(19) United States
(12) Patent Application Publication
(10) Pub. No.: US 2005/0246443 A1
(43) Pub. Date: Nov. 3, 2005

(54) Management of offload operations in a network storage driver

(75) Inventors: Xuebin Yao, Austin, TX (US); Navneet Malpani, Austin, TX (US)

Correspondence Address: KONRAD RAYNES & VICTOR, LLP;Suite 210, 315 S. Beverly Drive, Beverly Hills, CA, 90212, US

(73) Assignee: Intel Corporation

(21) Appl. No.: 10/815,897

(22) Filed: Mar. 31, 2004

(51) Int. Cl. G06F 15/16

(52) U.S. Cl. 709/227

(57) ABSTRACT

A network storage driver requests a connection from an offload application, wherein the offload application interfaces with a first network stack implemented in an operating system and a second network stack implemented in a hardware device. The connection is received from the offload application, wherein the received connection is an offloaded connection and is reserved for the network storage driver. Data is communicated over the offloaded connection through the hardware device.

### BACKGROUND

A host system may have a network device coupled to the host system for communications. In certain implementations, the communications may require the processing of commands related to the Transmission Control Protocol/Internet Protocol (TCP/IP) or any other protocol implemented over IP. A protocol is a set of rules, data formats, and conventions that regulates the transfer of data between communicating processes. The TCP/IP protocol may be implemented in software as a TCP/IP protocol stack as part of the operating system that is resident on the host system. In such a case, the central processing unit of the host system processes commands that are related to the TCP/IP protocol. Some network devices, such as, TCP Offload Engine (TOE) adapters, may provide hardware support for processing commands related to the TCP/IP protocol.

Internet Small Computer Systems Interface (iSCSI) is a protocol that defines methods for transporting Small Computer Systems Interface (SCSI) commands and data The iSCSI protocol is a transport protocol for SCSI commands and data that may be implemented over TCP.

Further details of TCP are described in the publication entitled “Transmission Control Protocol: DARPA Internet Program Protocol Specification,” prepared for the Defense Advanced Projects Research Agency (RFC 793, published September 1981). Further details of the iSCSI protocol are described in the publications entitled “Small Computer Systems Interface protocol over the Internet (iSCSI): Requirements and Design Considerations,” prepared by the Internet Engineering Task Force (RFC 3347, published July 2002) and “iSCSI,” prepared by the IP Storage Working Group of the Internet Engineering Task Force (Internet Draft draft-ietf-ips-iscsi-20.txt, published Jan. 19, 2003). Further details of the SCSI protocol are described in the publication entitled “SCSI Architecture Model-2” published by T10 Technical Committee of the InterNational Committee on Information Technology Standards (published Sep. 11, 2002).

### BRIEF DESCRIPTION OF THE DRAWINGS

Referring now to the drawings in which like reference numbers represent corresponding parts throughout:

FIG. 1 illustrates a block diagram of a computing environment, in accordance with certain embodiments;

FIG. 2 illustrates a block diagram of applications implemented in the computing environment, in accordance with certain embodiments;

FIG. 3 illustrates a block diagram of an iSCSI driver, in accordance with certain embodiments;

FIG. 4 illustrates a block diagram that indicates commands sent between applications in the computing environment, in accordance with certain embodiments;

FIG. 5 illustrates operations implemented in an iSCSI driver and an offload application, in accordance with certain embodiments; and

FIG. 6 illustrates a block diagram of a computer architecture for certain elements of the computing environment, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

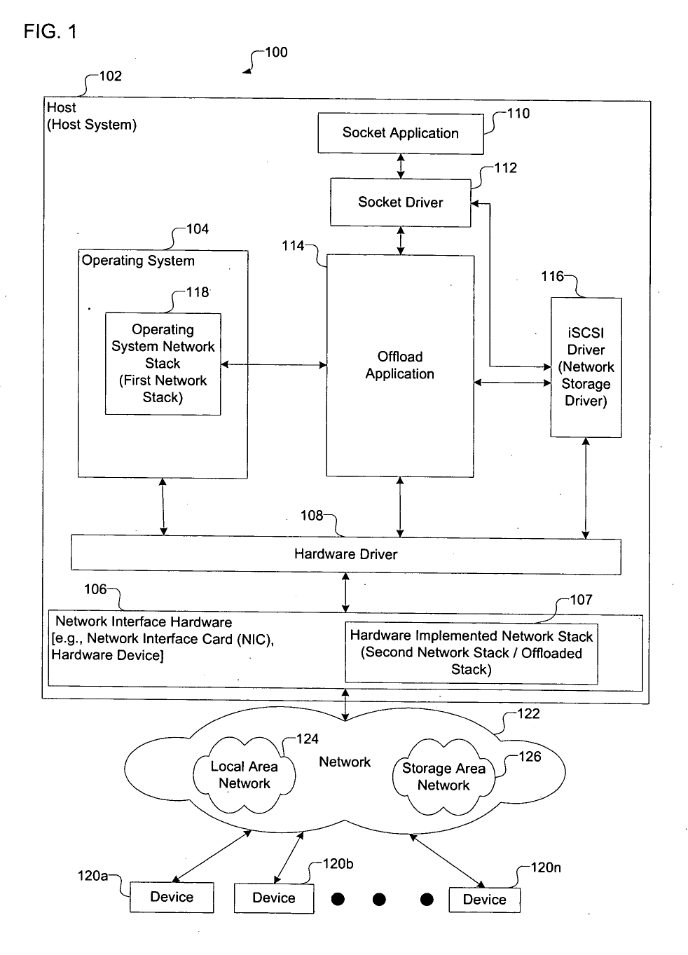

FIG. 1 illustrates a block diagram of a computing environment 100, in accordance with certain embodiments. A host system 102 may comprise an operating system 104, a network interface card (NIC) 106 having a hardware implemented network stack 107, a hardware driver 108, at least one socket application 110, a socket driver 112, an offload application 114 and an iSCSI driver 116.

The host system 102 may be a computational platform, such as, a personal computer, a workstation, a server, a mainframe, a hand held computer, a palm top computer, a laptop computer, a telephony device, a network appliance, etc. The operating system 104 may comprise the UNIX* operating system, the Microsoft Windows* operating system, the LINUX operating system, etc. The operating system 104 includes an implementation of an operating system network stack 118 that can process commands related to the Internet protocol in software.
*MICROSOFT WINDOWS is a trademark of Microsoft Corp.

*UNIX is a trademark of the Open Group.

The NIC 106 may comprise a network interface hardware, such as, a network adapter that includes hardware support for processing at least some commands related to at least one IP protocol, such as, the TCP/IP protocol. For example, the NIC 106 may include a TCP offload engine adapter that implements a network stack in hardware or software.

The hardware driver 108 provides a software interface for the NIC 106, such that, the operating system 104 and applications resident on the host 102 can use the NIC 106. The hardware driver 108 may manage the NIC 106 and any associated hardware resources, direct memory access, interrupts, etc. The hardware driver 108 may include routines for initializing and performing data flow operations on the NIC 106.

The socket application 110 uses socket interfaces for network communications. The socket application 110 may include Internet protocol based applications, such as, the File Transfer Protocol (FTP), TELNET, etc. The socket application 110 generates socket calls for network communications to the offload application 114 via the socket driver 112. Socket based network programming is supported by the socket driver 112 that transmits socket calls to the offload application 114. While the socket driver 112 has been shown outside the offload application 114, in certain embodiments the socket driver 112 may be implemented in the offload application 114. Although shown separately, the socket driver 112 can be considered to be part of the offload application 114. The socket driver 112 and the offload application 114 may together provide an offload framework for offloading processing tasks to the NIC 106.

The computational platform 102 is coupled to a plurality of devices 120a . . . 120n over a network 122. In certain embodiments the devices 120a . . . 120n may include iSCSI devices. The computational platform 102 may communicate commands and data with the iSCSI devices 120a . . . 120n via the NIC 106 coupled to the host system 102. In certain embodiments, the NIC 106 may function as a source device and the iSCSI devices 104a . . . 104n may function as target devices. The iSCSI devices 120a . . . 120n may include any device capable of supporting the iSCSI or other network storage protocols.

The network 122 may comprise the Internet, an intranet, a Local area network (LAN), a Storage area network (SAN), a Wide area network (WAN), a wireless network, etc. For example, in certain embodiments the network 122 may comprise a LAN 124 and a SAN 126. In such embodiments, the iSCSI driver 116 communicates iSCSI commands to the target iSCSI devices 120a . . . 120n over the SAN 126. The NIC 106 may also be capable of communicating data via the LAN 124, while data is being communicated over the SAN 126. In certain additional embodiments, the network 122 may be part of one or more larger networks or may be an independent network or may be comprised of multiple interconnected networks.

The iSCSI driver 116 may be a device driver that interfaces with the hardware driver 108 of the NIC 106. For example, in certain embodiments the iSCSI driver 116 may include functions for sending and receiving commands according to the iSCSI protocol over the network 122. In certain alternative embodiments, the iSCSI driver 116 may implement a network protocol that is different from iSCSI. In certain embodiments the iSCSI driver 116 comprises a network storage driver.

FIG. 1 illustrates certain embodiments in which the iSCSI driver 116 implements an iSCSI interface that can interface with the hardware driver 108 of the NIC 106 to communicate with the devices 120a . . . 120n over the network 122. The NIC 106 provides hardware support for processing of commands related to the Internet Protocol. When commands related to the Internet Protocol are processed by the NIC 106 the load on a central processing unit of the host 102 is reduced. The iSCSI driver 116 may use the hardware support provided by the NIC 106 for the processing of iSCSI commands.

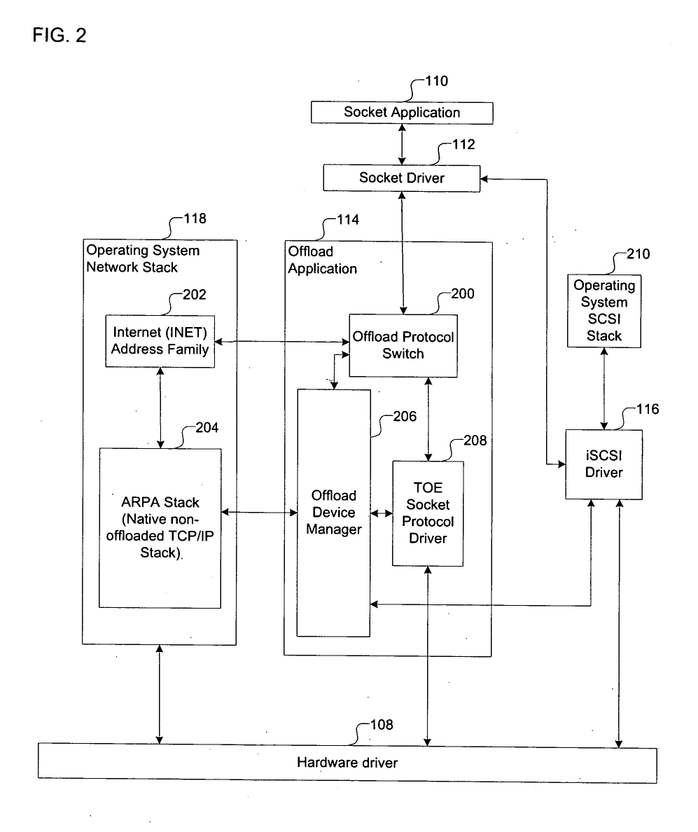

FIG. 2 illustrates a block diagram of interactions related to the offload application 114 and the iSCSI driver 116, in accordance with certain embodiments.

The offload application 114 includes an offload protocol switch 200 and one or more offload protocol drivers, such as, socket protocol drivers, that support various networking protocols. The offload protocol switch 200 determines if the NIC 106 provides hardware support for processing the network communications related to a socket call. If so, the offload protocol switch 200 forwards the socket call to the appropriate offload protocol drivers for processing. The offload protocol drivers use the hardware driver 108 to send the socket call to the NIC 106 for processing. If the offload protocol switch 200 determines that the NIC 106 does not provide support for processing the network communications related to the socket call, then the offload protocol switch 200 sends the socket call for processing via the operating system network stack 118 that is resident in the operating system 104. Certain embodiments may implement the offload application 114 in software, hardware, or in both software and hardware.

The operating system network stack 118 includes the Internet (INET) address family 202 and the Advanced Research Projects Agency (ARPA) stack 204. Sockets created by different programs use names to refer to one another. To be used, these names generally must be translated into addresses. The space that an address is drawn from is referred to as a domain. There are several domains for sockets of which the Internet address domain (AF_INET) is the UNIX implementation of the ARPA Internet standard protocols IP, TCP, and User Datagram Protocol (UDP). The INET address family 202 is the interface to the AF_INET domain.

The ARPA stack 204 may comprise a TCP layer and a UDP layer implemented over the IP layer and a framing layer. The ARPA stack 204 implements the TCP/IP and the UDP/IP protocols in software. The TCP layer implements the TCP protocols and the UDP layer implements the UDP protocols. The IP layer implements the IP protocols. The ARPA stack 204 can be referred to as the native non-offloaded TCP/IP stack.

In addition to the offload protocol switch 200, the offload application 114 includes an offload device manager 206, a TOE socket protocol driver 208, and other protocol drivers.

The offload protocol switch 200 can function as an address family module that is aware of INET transport protocol offloads and allows applications to use the offload capabilities of the NIC 106. The offload protocol switch 200 may handle multiple protocols in IP and can route sockets calls received from the socket driver 112 to the appropriate protocol. The offload protocol switch 200 may provide support both for protocols supported and not supported by the operating system network stack 118. For example, the offload protocol switch 200 may provide hardware support for the TCP/IP protocol by directing calls to a TCP/IP offload protocol driver, where the TCP/IP protocol is also supported in software by the operating system network stack 118.

The offload device manager 206 provides an interface for registration, notification and device management for various offload function modules. The offload device manger 206 may provide a single point of administration for all offload devices in the host system 102. In certain embodiments, the offload device manager 206 may register with the native non-offloaded TCP/IP stack 204 for event notifications and filter the notifications based on offload policies associated with the devices. The offload device manager 206 interacts with the operating system network stack 118 and the offload protocol switch 200. The offload device manager 206 also register devices capable of providing hardware support for IP. The offload device manager 206 may classify a received network event as an event that may be processed by the NIC 106 and may generate corresponding events for offload transport drivers.

The TOE socket protocol driver 208 exposes the protocol offload capabilities of the NIC 106 through the offload protocol switch 200. A provider of the TOE socket protocol driver 208 may map socket calls of the offload protocol switch 200 to input interfaces of the hardware driver 108.

An operating system SCSI stack 210 may implement a SCSI storage protocol in the operating system 104. In certain alternative embodiments, the operating system SCSI stack 210 may implement a protocol that does not directly support networked storage operations. For example, in certain exemplary embodiments the operating system SCSI stack 210 is not able to directly perform iSCSI operations with the devices 120a . . . 120n over the network 122. The operating system SCSI stack 210 may expose interfaces that may be used by the iSCSI driver 116. In certain embodiments the operating system SCSI stack 210 may be implemented in the kernel of the operating system 104, whereas in certain other embodiments the operating system SCSI stack 210 may be implemented outside the kernel of the operating system 104.

The iSCSI driver 116 may interface with the operating system SCSI stack 210, the socket driver 112, the offload device manager 206 and the hardware driver 108. In certain embodiments, the iSCSI driver 116 interacts with the offload application 114 and the hardware driver 108.

Therefore, FIG. 2 illustrates certain embodiments in which the iSCSI driver 116 interacts with the offload application 114 and the hardware driver 108 to provide support for iSCSI operations, such that, the TCP/IP stack implemented in the hardware of the NIC 106 is used for the iSCSI operations.

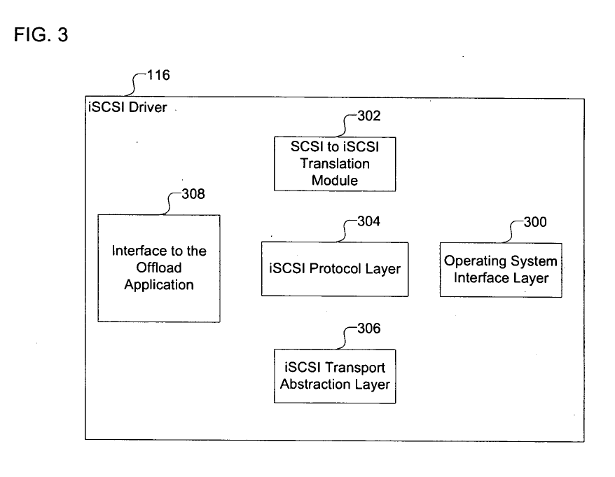

FIG. 3 illustrates a block diagram of exemplary components in the iSCSI driver 116, in accordance with certain embodiments. In certain embodiments, the iSCSI driver 116 may comprise an operating system interface layer 300, a SCSI to iSCSI translation module 302, an iSCSI protocol layer 304, an iSCSI transport abstraction layer 306, and an interface to the offload application 308.

The operating system interface layer 300 is specific to the operating system 104 implemented in the host 102. The operating system interface layer 300 provides support services that the iSCSI translation module 302, the iSCSI protocol layer 304, the iSCSI transport abstraction layer 306, and the interface to the offload application 308 can call to perform specific tasks with regard to driver initialization, timer services, memory management services, Input and Output Controls (IOCTL), driver statistics, debugging information, etc.

The SCSI to iSCSI translation module 302 provides functions for translating SCSI requests into iSCSI requests and forward the requests to the iSCSI protocol layer 304 for further processing. The SCSI to iSCSI translation module 302 can interface with the operating system SCSI stack 210.

The iSCSI protocol layer 304 comprises the implementations of the iSCSI protocol in the iSCSI driver 116.

The iSCSI transport abstraction layer 306 provides an abstracted transport interface, such that the iSCSI protocol layer 304 does not have to be aware of any operating system and hardware transport specifics for communicating commands to the NIC 106. The transport interface may be implemented via virtual socket application programming interfaces. The transport interfaces may be modified as changes are made to the hardware of the NIC 106 or as new versions of the operating system 104 are installed. As a result of the modifications to the transport interfaces of the iSCSI transport abstraction layer 306, no changes have to be made to the iSCSI protocol layer 304.

The interface to the offload application 308 may function as an iSCSI initiator and may depend on the offload application 114 to manage the TCP/IP configuration of iSCSI. The interface to the offload application 308 also uses the offload application 114 for socket creation, setup and teardown operation, handling of other IP based packets and event notifications such as device discovery, etc.

FIG. 3 illustrates an embodiment in which the iSCSI driver 116 has certain components. In alternative embodiments, the components may be fewer or more in number and may have different, additional, or fewer functions.

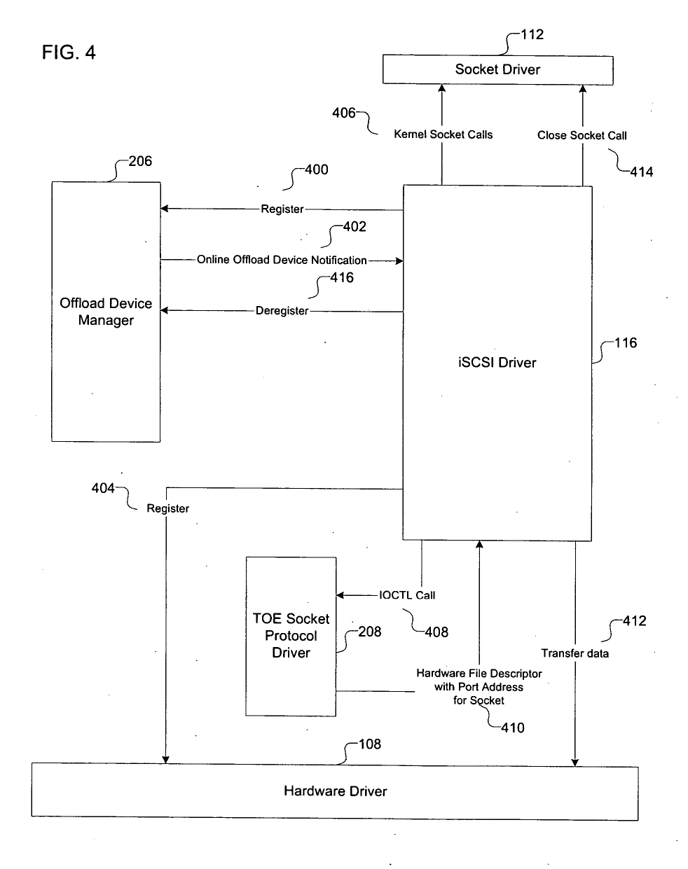

FIG. 4 illustrates a block diagram that indicates how commands sent between applications in the computing environment 100, in accordance with certain embodiments.

For the iSCSI driver 116 to work in association with the offload application 114 and to allow the iSCSI driver 116 to use the hardware TCP/IP offload capability of the NIC 106, an exemplary sequence of operations illustrated in FIG. 4 may be performed.

When the iSCSI driver 116 is loaded, the iSCSI driver 116 may register (reference numeral 400) with the offload device manager 206. The offload device manager 206 may notify (reference numeral 402) the iSCSI driver 116 when the NIC 106 is online, i.e., the link level hardware device has been configured with an IP address. The iSCSI driver 116 may also have provided a list of notifications of interest to the offload device manger 206.

When the offload device manager 206 notifies the iSCSI driver 116 of the online status of the NIC 106, the iSCSI driver 116 may then register (reference numeral 404) with the hardware driver 108 to secure the desired resources. After the iSCSI hardware resources have been reserved, the iSCSI driver 116 may read a configuration file and determine the number of sockets required by the iSCSI driver 116 to create one or more connections across the network 122. Based on the number of sockets needed, the iSCSI driver 116 makes kernel socket calls (reference numeral 408) to the socket driver 112. The socket driver 112 may use the offload application 114 and returns sockets to the iSCSI driver 116. The sockets are reserved for the iSCSI driver 116 and other applications may not use the sockets. The TCP connections corresponding to the sockets are non-conflicting and may be used as offloaded TCP connections, i.e., the offloaded stack 107 on the NIC 106 may be used for communicating data via the TCP connections.

After the one or more TCP connections are created, the iSCSI driver 116 may generate an IOCTL call (reference numeral 408) in the TOE socket protocol driver 208 and provide an asynchronous event callback routine for the corresponding socket. The TOE socket protocol driver 208 may return a hardware file descriptor (reference numeral 410) for the socket to the iSCSI driver 116.

The iSCSI driver 116 can then start transferring data (reference numeral 412) on the socket. The iSCSI driver 116 may perform iSCSI operations for iSCSI login and full feature phase requests and transfer data through the hardware driver 108.

When the iSCSI driver 116 no longer needs a socket, the iSCSI driver 116 may generate a command to close (reference numeral 414) the socket in the socket driver 112 associated with the offload application 114. The iSCSI driver 116 may request the offload application 114 to teardown the associated TCP connection and clean up the offload resources associated with the TCP connection. In certain embodiments, the iSCSI driver 116 may also deregister (reference numeral 416) from the offload device manger 206.

FIG. 4 illustrates an embodiment in which the iSCSI driver secures unique non-conflicting TCP connections from the offload application 114 and uses the TCP connections to exploit the offloaded stack 107 of the NIC 106 to communicate with the devices 120a . . . 120n over the network 122. Adding connections, creating sessions, deleting sessions, logging in and logging out may be performed in association with certain embodiments.

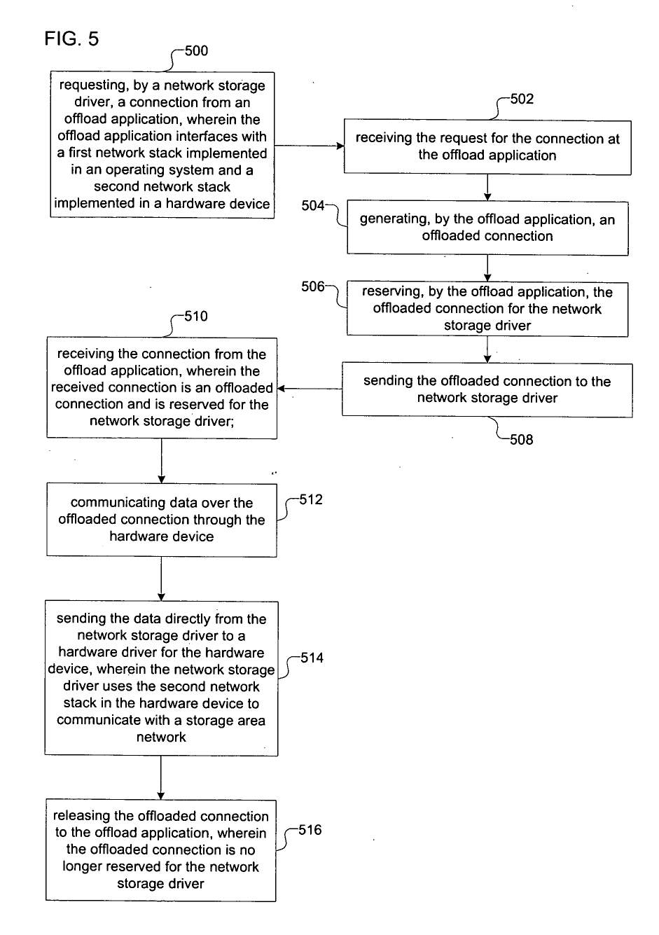

FIG. 5 illustrates operations implemented in an iSCSI driver 116 and the offload application 114, in accordance with certain embodiments.

Control starts at block 500, where a network storage driver, such as the iSCSI driver 116, requests a connection from the offload application 114, wherein the offload application 114 interfaces with a first network stack 118 implemented in the operating system 104 and a second network stack, such as, the hardware implemented network stack 107, implemented in a hardware device, such as the NIC 106.

The offload application 114 receives (at block 502) the request for the connection from the iSCSI driver 116. The offload application 114 generates (at block 504) an offloaded connection and reserves (at block 506) the offloaded connection for the iSCSI driver 116. In certain embodiments, the offloaded connection may be generated and reserved as described in FIG. 4. The offload application 114 sends the offloaded connection (at block 508) to the iSCSI driver 116.

The iSCSI driver 116 receives (at block 510) the offloaded connection from the offload application 114, where the offloaded connection is reserved for the iSCSI driver 116, i.e., other drivers and applications are not allowed to use the offloaded connection without authorization from the iSCSI driver 116.

The iSCSI driver 116 communicates (at block 512) data over the offloaded connection through a hardware device, such as the NIC 106. In certain embodiments, the data is sent (at block 514) directly from the iSCSI driver 116 to the hardware driver 108 for the NIC 106, wherein the NIC 106 uses the hardware implemented network stack 107 to communicate with the storage area network 126.

The iSCSI driver 116 may release (at block 516) the offloaded connection to the offload application 114 and the offloaded connection is no longer reserved for the iSCSI driver 116.

In certain embodiments, the offloaded connection is a TCP/IP connection included in a file descriptor sent from the offload application 114 to the network storage driver 116, and the file descriptor may include a port address that is reserved for the network storage driver 116. In certain additional embodiments, the network storage driver 116 implements an iSCSI protocol for communicating with a target storage device, such as, any of the devices 120a . . . 120n, through the hardware device 106. In yet additional embodiments, the first network stack 118 and the second network stack 107 do not implement the iSCSI protocol.

In further embodiments, the first network stack 118 and the second network stack 107 comprise an Internet address family and a Transmission Control protocol implemented over an IP network layer, wherein the offload application 114 can offload a network communication request to the second network stack 107 in preference to the first network stack 118, and wherein a single stack behavior is maintained by the first and second network stacks to applications and network management utilities. In certain embodiments, the hardware device 106 is a TOE adapter, and a network communication request for communicating the data is processed faster in the second network stack 107 when compared to the first network stack 118.

FIG. 5 describes certain embodiments in which the iSCSI driver 116 receives a non-conflicting connection from the offload application 114, and uses the non-conflicting connection to use the hardware implemented network stack 107 of the NIC 106 for communication across the SAN 126.

Certain embodiments provide a network storage driver 116 over an offload framework implemented by the offload application 114, where the offload framework allows the network storage driver to use the TCP/IP protocol offload capabilities of the NIC 106 though the offload framework's device management capabilities.

Certain embodiments allow an operating system stack for IP storage 210, a native operating system network stack 118 and the network protocol offload stack 107 in NIC hardware to co-exist and work in association with each other. Certain embodiments may allow unified network management and provide an unified administrative interface across a plurality of network stacks.

Certain applications may use existing legacy application programming interfaces and interfaces such as sockets to perform network programming and use the SCSI interface for block storage. Such legacy applications can function with certain embodiments without any changes to such legacy applications.

Certain embodiments may support simultaneous protocol offloading and acceleration for network protocols, such as, TCP/IP, and storage protocols, such as, iSCSI, over multi-function offload adapters.

The described techniques may be implemented as a method, apparatus or article of manufacture involving software, firmware, micro-code, hardware and/or any combination thereof. The term “article of manufacture” as used herein refers to program instructions, code and/or logic implemented in circuitry (e.g., an integrated circuit chip, Programmable Gate Array (PGA), ASIC, etc.) and/or a computer readable medium (e.g., magnetic storage medium, such as hard disk drive, floppy disk, tape), optical storage (e.g., CD-ROM, DVD-ROM, optical disk, etc.), volatile and non-volatile memory device (e.g., Electrically Erasable Programmable Read Only Memory (EEPROM), Read Only Memory (ROM), Programmable Read Only Memory (PROM), Random Access Memory (RAM), Dynamic Random Access Memory (DRAM), Static Random Access Memory (SRAM), flash, firmware, programmable logic, etc.). Code in the computer readable medium may be accessed and executed by a machine, such as, a processor. In certain embodiments, the code in which embodiments are made may further be accessible through a transmission medium or from a file server via a network. In such cases, the article of manufacture in which the code is implemented may comprise a transmission medium, such as a network transmission line, wireless transmission media, signals propagating through space, radio waves, infrared signals, etc. Of course, those skilled in the art will recognize that many modifications may be made without departing from the scope of the embodiments, and that the article of manufacture may comprise any information bearing medium known in the art. For example, the article of manufacture comprises a storage medium having stored therein instructions that when executed by a machine results in operations being performed. The storage medium may comprise any information bearing medium known in the art including a transmission medium. Furthermore, program logic that includes code may be implemented in hardware, software, firmware or any combination thereof.

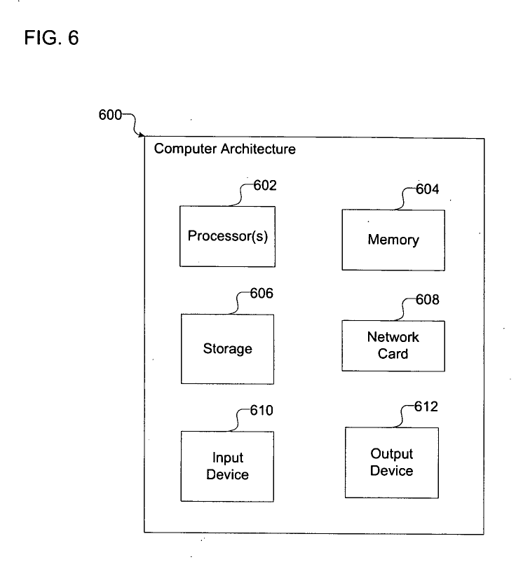

FIG. 6 illustrates a block diagram of a computer architecture in which certain embodiments are implemented. FIG. 6 illustrates one embodiment of the host system 102 and the network interface hardware 106. The host system 102 and the network interface hardware 106 may implement a computer architecture 600 having one or more processors 602, a memory 604 (e.g., a volatile memory device), and storage 606. Not all elements of the computer architecture 600 may be found in the host system 102 and the network interface hardware 106. The storage 606 may include a non-volatile memory device (e.g., EEPROM, ROM, PROM, RAM, DRAM, SRAM, flash, firmware, programmable logic, etc.), magnetic disk drive, optical disk drive, tape drive, etc. The storage 606 may comprise an internal storage device, an attached storage device and/or a network accessible storage device. Programs in the storage 606 may be loaded into the memory 604 and executed by the one or more processors 602 in a manner known in the art. The architecture may further include a network card 608 to enable communication with a network. The architecture may also include one input device 610, such as a keyboard, a touchscreen, a pen, voice-activated input, etc., and one output device 612, such as a display device, a speaker, a printer, etc.

In certain embodiments, the network interface hardware 106, may be included in a computer system including any storage controller, such as, a Small Computer System Interface (SCSI), AT Attachment Interface (ATA), Redundant Array of Independent Disk (RAID), etc., controller, that manages access to a non-volatile storage device, such as a magnetic disk drive, tape media, optical disk, etc. In alternative embodiments, the network interface hardware 106 may be included in a system that does not include a storage controller, such as certain hubs and switches.

Certain embodiments may be implemented in a computer system including a video or graphics controller to render information to display on a monitor coupled to the computer system including the network interface hardware 106, where the computer system may comprise a desktop, workstation, server, mainframe, laptop, handheld computer, etc. An operating system may be capable of execution by the computer system, and the video controller may render graphics output via interactions with the operating system. Alternatively, some embodiments may be implemented in a computer system that does not include a video or graphics controller, such as a switch, router, etc. Furthermore, in certain embodiments the network interface hardware 106 may be included in a card coupled to a computer system or on a motherboard of a computer system.

At least certain of the operations of FIG. 5 can be performed in parallel as well as sequentially. In alternative embodiments, certain of the operations may be performed in a different order, modified or removed. In alternative embodiments, certain operations of FIG. 5 may be implemented in the network interface hardware 106. Furthermore, many of the software and hardware components have been described in separate modules for purposes of illustration. Such components may be integrated into a fewer number of components or divided into a larger number of components. Additionally, certain operations described as performed by a specific component may be performed by other components.

The data structures and components shown or referred to in FIGS. 1-6 are described as having specific types of information. In alternative embodiments, the data structures and components may be structured differently and have fewer, more or different fields or different functions than those shown or referred to in the figures.

Therefore, the foregoing description of the embodiments has been presented for the purposes of illustration and description. It is not intended to be exhaustive or to limit the embodiments to the precise form disclosed. Many modifications and variations are possible in light of the above teaching.

1. A method, comprising:
requesting, by a network storage driver, a connection from an offload application, wherein the offload application interfaces with a first network stack implemented in an operating system and a second network stack implemented in a hardware device;
receiving the connection from the offload application, wherein the received connection is an offloaded connection and is reserved for the network storage driver; and
communicating data over the offloaded connection through the hardware device.

2. The method of claim 1, wherein communicating the data over the offloaded connection further comprises:
sending the data directly from the network storage driver to a hardware driver for the hardware device, wherein the network storage driver uses the second network stack implemented in the hardware device to communicate with a storage area network.

3. The method of claim 1, further comprising:
releasing the offloaded connection to the offload application, wherein the offloaded connection is no longer reserved for the network storage driver.

4. The method of claim 1, further comprising:
receiving the request for the connection at the offload application;
generating, by the offload application, the offloaded connection;
reserving, by the offload application, the offloaded connection for the network storage driver; and
sending the offloaded connection to the network storage driver.

5. The method of claim 1, wherein the connection is a Transmission Control Protocol/Internet Protocol connection included in a file descriptor sent from the offload application to the network storage driver, and wherein the file descriptor includes a port address that is reserved for the network storage driver.

6. The method of claim 1, wherein the network storage driver implements an Internet Small Computer Systems Interface protocol for communicating with a target storage device through the hardware device.

7. The method of claim 1, wherein the first network stack and the second network stack do not implement an Internet Small Computer Systems Interface protocol.

8. The method of claim 1, wherein the first network stack and the second network stack comprise an Internet address family and a Transmission Control protocol implemented over an Internet Protocol network layer, wherein the offload application can offload a network communication request to the second network stack in preference to the first network stack, and wherein a single stack behavior is maintained by the first and second network stacks to applications and network management utilities.

9. The method of claim 1, wherein the hardware device is a Transmission Control Protocol offload engine adapter, and wherein a network communication request for communicating the data is processed faster in the second network stack in comparison to the first network stack.

10. A system, comprising:
a processor; and
program logic including code that is capable of causing the processor to be operable to:
request, by a network storage driver, a connection from an offload application, wherein the offload application interfaces with a first network stack implemented in an operating system and a second network stack implemented in a hardware device;
receive the connection from the offload application, wherein the received connection is an offloaded connection and is reserved for the network storage driver; and
communicate data over the offloaded connection through the hardware device.

11. The system of claim 10, wherein the program logic is further capable of causing the processor to be operable to:
send the data directly from the network storage driver to a hardware driver for the hardware device, wherein the network storage driver uses the second network stack implemented in the hardware device to communicate with a storage area network.

12. The system of claim 10, wherein the program logic is further capable of causing the processor to be operable to:
release the offloaded connection to the offload application, wherein the offloaded connection is no longer reserved for the network storage driver.

13. The system of claim 10, wherein the program logic is further capable of causing the processor to be operable to:
receive the request for the connection at the offload application;
generate, by the offload application, the offloaded connection;
reserve, by the offload application, the offloaded connection for the network storage driver; and
send the offloaded connection to the network storage driver.

14. The system of claim 10, wherein the connection is a Transmission Control Protocol/Internet Protocol connection included in a file descriptor sent from the offload application to the network storage driver, and wherein the file descriptor includes a port address that is reserved for the network storage driver.

15. The system of claim 10, wherein the network storage driver implements an Internet Small Computer Systems Interface protocol for communicating with a target storage device through the hardware device.

16. The system of claim 10, wherein the first network stack and the second network stack do not implement an Internet Small Computer Systems Interface protocol.

17. The system of claim 10, wherein the first network stack and the second network stack comprise an Internet address family and a Transmission Control protocol implemented over an Internet Protocol network layer, wherein the offload application can offload a network communication request to the second network stack in preference to the first network stack, and wherein a single stack behavior is maintained by the first and second network stacks to applications and network management utilities.

18. The system of claim 10, wherein the hardware device is a Transmission Control Protocol offload engine adapter, and wherein a network communication request for communicating the data is processed faster in the second network stack in comparison to the first network stack.

19. A system, comprising:
a computational platform;
a storage controller implemented in the computational platform;
a processor coupled to the computational platform;
an offload adapter coupled to the computational platform; and
program logic including code that is capable of causing the processor to be operable to:
request, by a network storage driver, a connection from an offload application, wherein the offload application interfaces with a first network stack implemented in an operating system and a second network stack implemented in the offload adapter;
receive the connection from the offload application, wherein the received connection is an offloaded connection and is reserved for the network storage driver; and
communicate data over the offloaded connection through the offload adapter.

20. The system of claim 19, wherein the program logic is further capable of causing the processor to be operable to:
release the offloaded connection to the offload application, wherein the offloaded connection is no longer reserved for the network storage driver.

21. The system of claim 19, wherein the program logic is further capable of causing the processor to be operable to:
receive the request for the connection at the offload application;
generate, by the offload application, the offloaded connection;
reserve, by the offload application, the offloaded connection for the network storage driver; and
send the offloaded connection to the network storage driver.

22. An article of manufacture, comprising a storage medium having stored therein instructions capable of being executed by a machine to:
request, by a network storage driver, a connection from an offload application, wherein the offload application interfaces with a first network stack implemented in an operating system and a second network stack implemented in a hardware device;
receive the connection from the offload application, wherein the received connection is an offloaded connection and is reserved for the network storage driver; and communicate data over the offloaded connection through the hardware device.

23. The article of manufacture of claim 22, wherein the instructions are further capable of being executed by a machine to:
send the data directly from the network storage driver to a hardware driver for the hardware device, wherein the network storage driver uses the second network stack implemented in the hardware device to communicate with a storage area network.

24. The article of manufacture of claim 22, wherein the instructions are further capable of being executed by a machine to:
release the offloaded connection to the offload application, wherein the offloaded connection is no longer reserved for the network storage driver.

25. The article of manufacture of claim 22, wherein the instructions are further capable of being executed by a machine to:
receive the request for the connection at the offload application;
generate, by the offload application, the offloaded connection;
reserve, by the offload application, the offloaded connection for the network, storage driver; and
send the offloaded connection to the network storage driver.

26. The article of manufacture of claim 22, wherein the connection is a Transmission Control Protocol/Internet Protocol connection included in a file descriptor sent from the offload application to the network storage driver, and wherein the file descriptor includes a port address that is reserved for the network storage driver.

27. The article of manufacture of claim 22, wherein the network storage driver implements an Internet Small Computer Systems Interface protocol for communicating with a target storage device through the hardware device.

28. The article of manufacture of claim 22, wherein the first network stack and the second network stack do not implement an Internet Small Computer Systems Interface protocol.

29. The article of manufacture of claim 22, wherein the first network stack and the second network stack comprise an Internet address family and a Transmission Control protocol implemented over an Internet Protocol network layer, wherein the offload application can offload a network communication request to the second network stack in preference to the first network stack, and wherein a single stack behavior is maintained by the first and second network stacks to applications and network management utilities.

30. The article of manufacture of claim 22, wherein the hardware device is a Transmission Control Protocol offload engine adapter, and wherein a network communication request for communicating the data is processed faster in the second network stack in comparison to the first network stack.
